(19) United States
(12) Patent Application Publication
(10) Pub. No.: US 2024/0269802 A1
(43) Pub. Date: Aug. 15, 2024

(54) ROTARY ABRASIVE MACHINING

(71) Applicant: Element Six (UK) Limited, Oxfordshire (GB)

(72) Inventors: Gregory Trevor LUPTON, Oxfordshire (GB); Luiz Fernando PENNA FRANCA, Oxfordshire (GB); Matthew LAY, Oxfordshire (GB); Brian GILROY, Oxfordshire (GB)

(21) Appl. No.: 18/570,292

(22) PCT Filed: Jun. 15, 2022
(86) PCT No.: PCT/EP2022/066378

§ 371 Date: Dec. 14, 2023

(30) Foreign Application Priority Data
Jun. 23, 2021 (GB) 2109030.3

(51) Int. Cl. B24D 5/06; B24D 5/16

(52) U.S. Cl. CPC B24D 5/06; B24D 5/16

(57) ABSTRACT

This disclosure relates to a rotary abrasive machining tool comprising a hub with a plurality of axially extending radial slots in an outer circumference thereof, and a plurality of abrasive segments, typically polycrystalline diamond, located in the radial slots.

### FIELD OF THE INVENTION

This disclosure relates to apparatus for rotary abrasive machining. In particular, it relates to rotary dressing tools.

### BACKGROUND

EP 3 415 275 A2 discloses a rotary abrasive machining tool 101 comprising a hub 103 having a plurality of axially-oriented radial slots in the outer circumference thereof. A plurality of abrasive segments 201, 202 are located in the radial slots 701, 702, together forming an abrading surface 102. Each abrasive segment comprises an abrading edge 402, 403 defining a plurality of abrasive segments 405 and further comprising a tab 401 for location in one of the slots in the hub. In one of the embodiments, the tab is wider at its base than at its upper portion. A pair of flanges 104, 105 are screwed to the hub 103, thereby securing the abrasive segments in position as rims 504, 505 cooperate with the wider base of the tab 401—see FIGS. 5 and 6. In another embodiment, rings 1103 are used to secure the abrasive segments in position—see FIGS. 11 and 12.

A problem with these arrangements is that it is difficult to individually replace an abrasive segment if damaged or worn.

It is therefore an aim of the invention to provide an alternative way of mounting the abrasive segments in the hub that addresses the above-mentioned problem.

### SUMMARY OF THE INVENTION

In accordance with the invention, there is provided a rotary abrasive machining tool comprising a hub with a plurality of axially extending radial slots in an outer circumference thereof, a plurality of abrasive segments located in the radial slots, each abrasive segment having a tab for mounting the abrasive segment in the hub and further comprising an abrading edge, characterised in that each abrasive segment individually secured to the hub using a pin element that extends at least partially through the abrasive segment and/or at least partially through the hub adjacent the abrasive segment.

This arrangement is advantageous as it enables an individual segment to be replaced without disturbing the rest of the abrasive segments from their positions. Furthermore, it enables further use of the rotary abrasive machining tool with an individual abrasive segment (or more) missing. Moreover, realignment of the abrasive segments after the individual segment has been replaced is simpler since only the individual segment must be profiled relative to the remaining abrasive segments. This contrasts with the prior art solution in which all of the abrasive segments would require profiling. Above all, the most significant benefit of the arrangement is that the abrasive segments can be produced with significantly less volume of material. This leads to substantial cost reduction in terms of both raw material and production processes.

Optional and/or preferable features of the invention are provided in the dependent claims.

### BRIEF DESCRIPTION OF THE DRAWINGS

The invention will now be more particularly described, by way of example only, with reference to the accompanying drawings, in which:

FIG. 1 is a perspective view of a first embodiment of a rotary abrasive machining tool;

FIG. 2 is an end view of the tool of FIG. 1;

FIG. 3 is a front view of the tool of FIG. 1;

FIG. 4 is a cross-sectional view taken through the line A-A of FIG. 3,

FIG. 5 is an enlarged view of encircled zone D from FIG. 4, in which the enlarged zone is drawn to a scale of 1.5:1;

FIG. 6 is an enlarged view of encircled zone B from FIG. 4, in which the enlarged zone is drawn to a scale of 1.5:1;

FIG. 7 is a partial perspective view of the tool of FIG. 1;

FIG. 8 is a cross-sectional view through the tool of FIG. 1;

FIG. 9 is a close-up partial perspective view of abrasive segments mounted on the hub in the tool of FIG. 1;

FIG. 10 is a perspective view from the front of the hub in FIG. 1;

FIG. 11 is a perspective view from the rear of the hub in FIG. 1;

FIG. 12 is a perspective view of an individual abrasive segment from FIG. 1;

FIG. 13 is a side view of the abrasive segment of FIG. 14;

FIG. 14 is a schematic image showing a configuration of nested abrasive segments overlaid onto a blank before the abrasive segments are machined from the blank;

FIG. 15 is a graph showing the relationship between thickness (in millimetres, mm) of an individual abrasive segment and the quantity of abrasive segments (referred to in the graph as ‘blades’) required;

FIG. 16 is an end view of the abrasive segment of FIG. 12;

FIG. 17 is a close-up schematic image of a partial aperture on the abrasive segment fully aligned with a partial aperture on the hub, ready to receive a pin element;

FIG. 18 is a cross-sectional view through the tool of FIG. 1 when incorporating spring pins;

FIG. 19 is a close-up schematic image showing the alignment of the gap in the spring pin with surfaces of the abrasive segment and the hub;

FIG. 20 is a perspective view of a second embodiment of a rotary abrasive machining tool;

FIG. 21 is a plan view of the tool of FIG. 20;

FIG. 22 is a front view of the tool of FIG. 20;

FIG. 23 is a cross-sectional view through the line C-C in FIG. 22;

FIG. 24 is an enlarged view of encircled zone D from FIG. 23, in which the enlarged zone is drawn to a scale of 2:1;

FIG. 25 is a perspective view of the flange used in the tool of FIG. 20;

FIG. 26 is a perspective view of the hub used in the tool of FIG. 20;

FIG. 27 is a first embodiment of an intermediate tool holder for use in the tool of FIGS. 20, 30 and 37;

FIG. 28 is a second embodiment of an intermediate tool holder for use in the tool of FIGS. 20, 30 and 37;

FIG. 29 is a third embodiment of an intermediate tool holder for use in the tool of FIGS. 20, 30 and 37;

FIG. 30 is a perspective view of a third embodiment of a rotary abrasive machining tool;

FIG. 31 is a plan view of the tool of FIG. 30;

FIG. 32 is a front view of the tool of FIG. 30;

FIG. 33 is a cross-sectional view through the line A-A in FIG. 32;

FIG. 34 is an enlarged view of encircled zone B from FIG. 33, in which the enlarged zone is drawn to a scale of 2:1;

FIG. 35 is a perspective view of the flange used in the tool of FIG. 30;

FIG. 36 is a perspective view of the hub used in the tool of FIG. 30;

FIG. 37 is a partial perspective view of a fourth embodiment of a rotary abrasive machining tool;

FIG. 38 is a front view of the abrasive segment mounted in the intermediate tool holder of

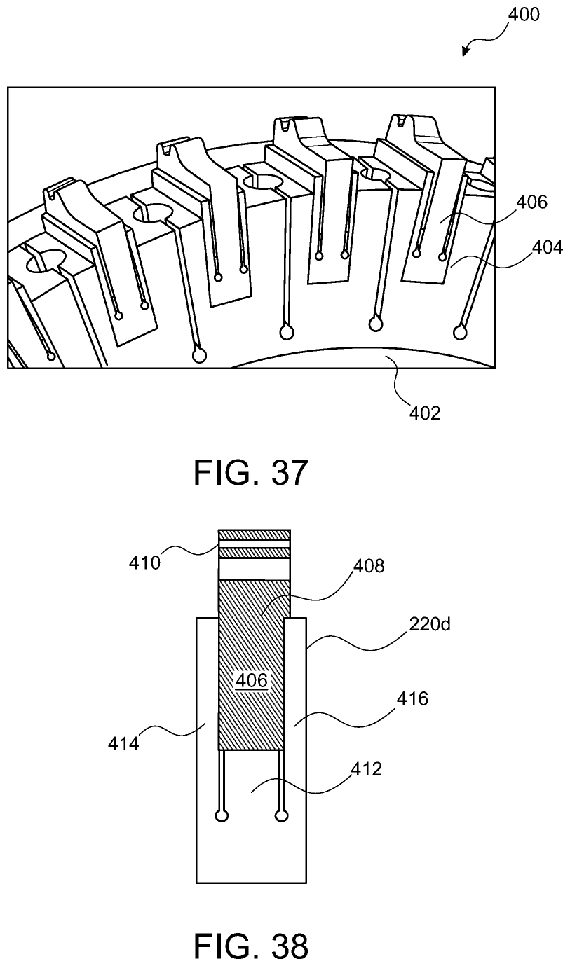

FIG. 37;

FIG. 39 is a schematic image illustrating the reduction in the use of material in an embodiment of the abrasive segment compared with the prior art;

FIG. 40 is a lateral cross-sectional view through an embodiment of the abrasive segment, and shows a layer of polycrystalline diamond (PCD) mounted on a carbide substrate; and

FIGS. 41a, 41b and 41c are schematic drawings showing the position of the interface between the PCD and carbide substrate relative to different positions of the centreline of the hub.

### DETAILED DESCRIPTION

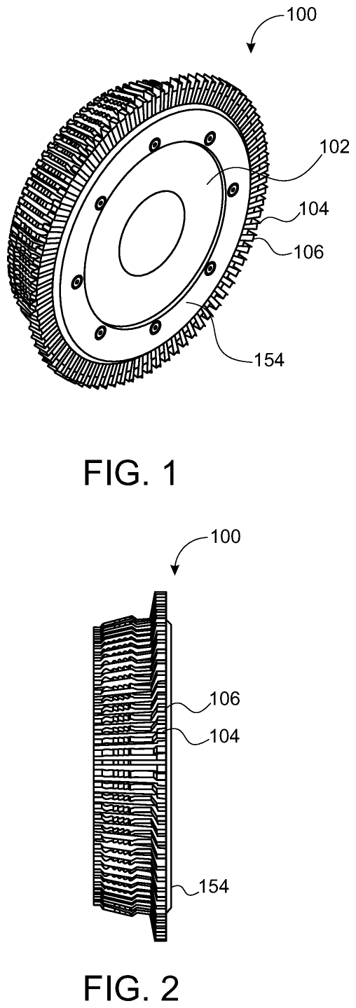

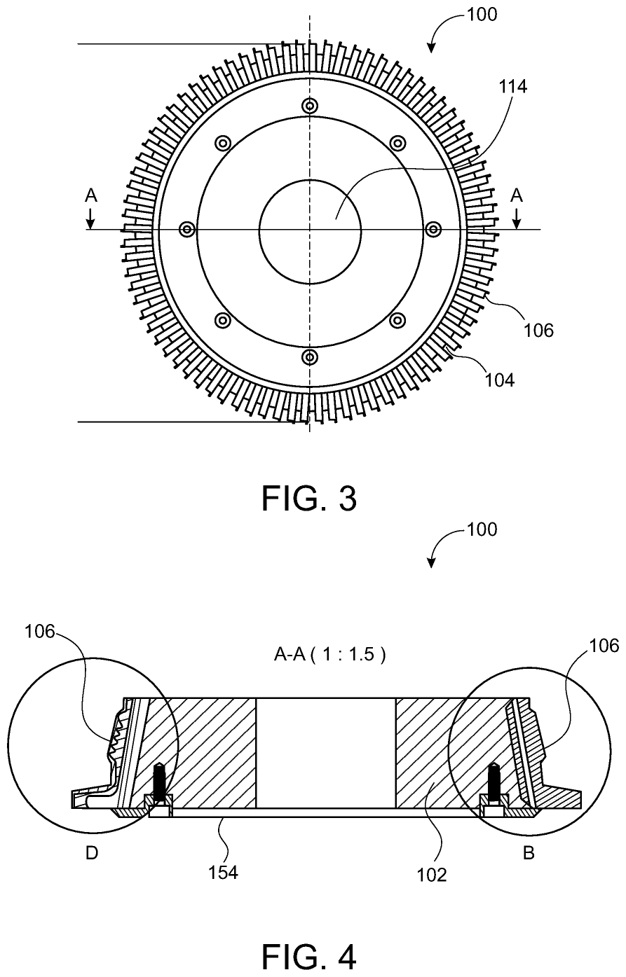

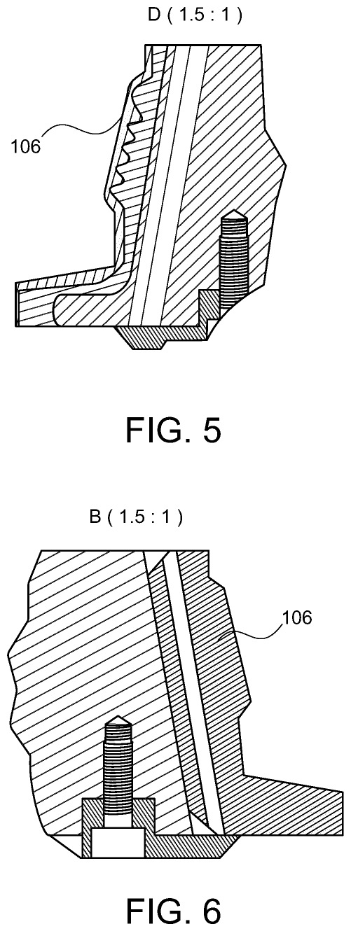

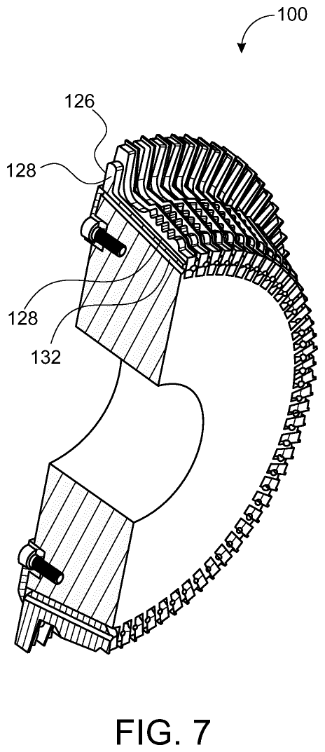

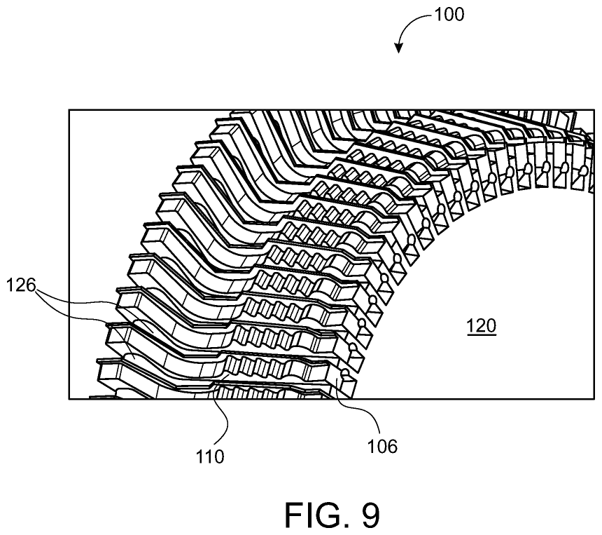

Referring to FIGS. 1 to 9, a first embodiment of a rotary abrasive machining tool is indicated generally at 100. The rotary abrasive machining tool 100 comprises a hub 102 with a plurality of axially extending radial slots 104 in an outer circumference thereof, and a plurality of abrasive segments 106 located in the radial slots. Each abrasive segment has a body 108 for mounting the abrasive segment in the hub and further comprises an abrading edge 110. Each abrasive segment is individually secured to the hub using a pin element 112 that extends at least partially through the abrasive segment and/or at least partially through the hub adjacent the abrasive segment.

In this first embodiment, the pin element extends axially, partially through the abrasive segment and partially through the hub adjacent the abrasive segment—as described in further detail below.

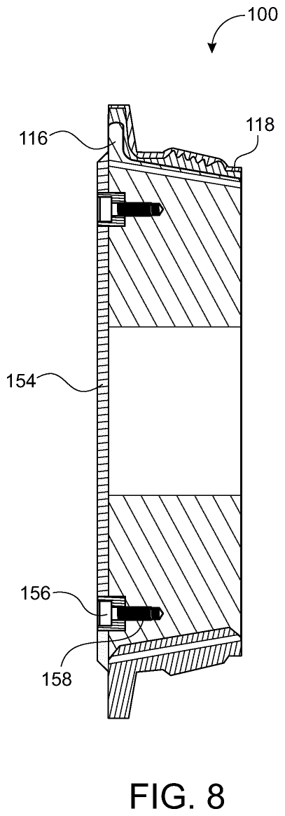

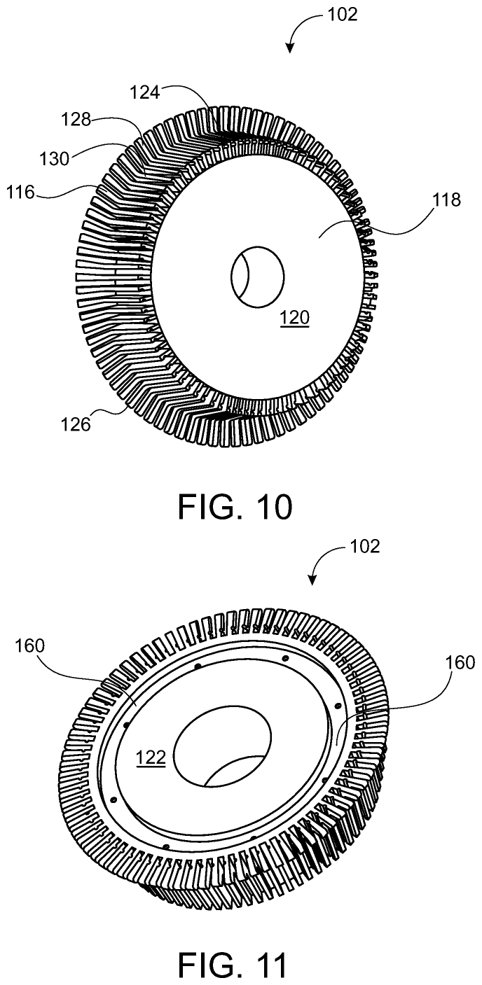

The hub is annular with a central aperture 114 for mounting onto the rotatable shaft of a rotary dressing machine (not shown). The general shape of the hub is akin to a pipe flange, in that it has a ring portion 116 and a raised surface 118 to one side, best seen in FIG. 8. The hub comprises opposing first and second major axial surfaces 120, 122—see FIGS. 10 and 11. An outer circumferential surface 124, which connects the first and second major axial surfaces, generally tapers radially inwardly from one side to the other.

The slots extend axially between the first and second major axial surfaces. The slots also extend radially into the hub, thereby defining a series of supports 126 between the slots. For each slot, there is an adjacent support. Each support is generally L-shaped with a first support leg portion 128 that extends radially and a second support leg portion 130 that extends axially. The first support leg portion is shorter than the second support leg portion. The first support leg portion is located adjacent to the first major axial surface and the second support leg portion terminates at the second major axial surface.

A first pin recess 132 for partially receiving the pin element extends along the longitudinal extent of each support. The first pin recess has a semi-circular lateral cross-section and is intended to become complete, i.e. fully circular, when aligned with another pin recess having a semi-circular lateral cross-section. This is explained in further detail below.

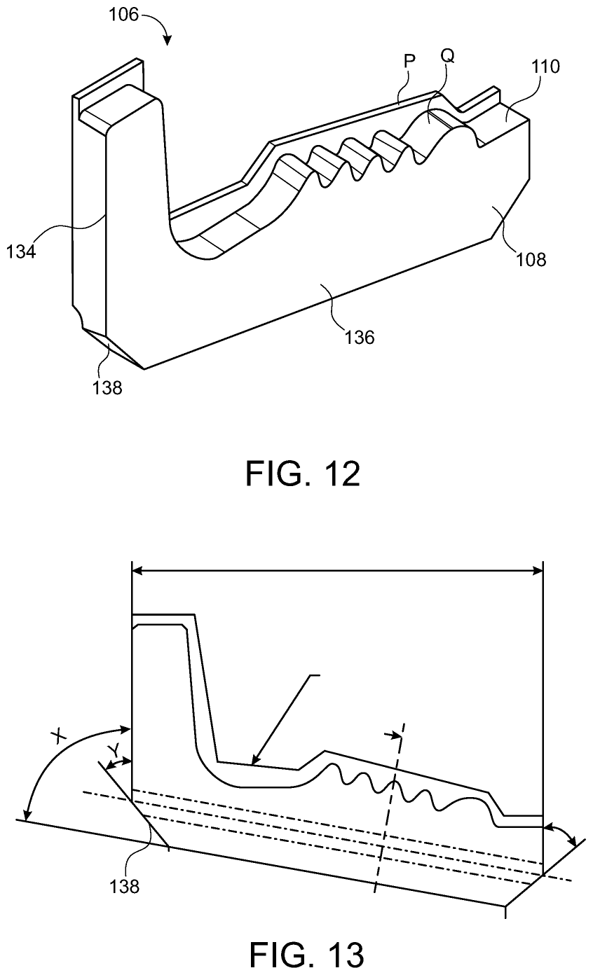

In the first embodiment, each abrasive segment is also generally L-shaped, best seen in FIG. 12. As such, the abrasive segment comprises a first segment leg portion 134 extending from a second segment leg portion 136. The first segment leg portion is shorter than the second segment leg portion. The first segment leg portion extends at an angle X to the second segment leg portion, and angle X is in the range of 75 to 100 degrees. Angle X is measured between outer surfaces of the first and second segment leg portions, as indicated in FIG. 13. Preferably, angle X is around 80 degrees.

The L-shaped configuration makes the resulting rotary abrasive machining tool particularly suitable for machining fir-tree profiles. The L-shape helps to minimise the volume of material required in the abrasive segment for the machining operation. This is especially important when more expensive superhard materials such as PCD or polycrystalline cubic boron nitride (PCBN) are required for maximum wear resistance and prolonged service life.

Each abrasive segment is inserted into a slot, in between two supports. Once in its final position, the first segment leg portion aligns with the first support leg portion of the hub, and the second segment leg portion aligns with the second support leg portion. The L-shaped configuration of the supports helps to minimise the mass of the hub, providing support only where it is needed.

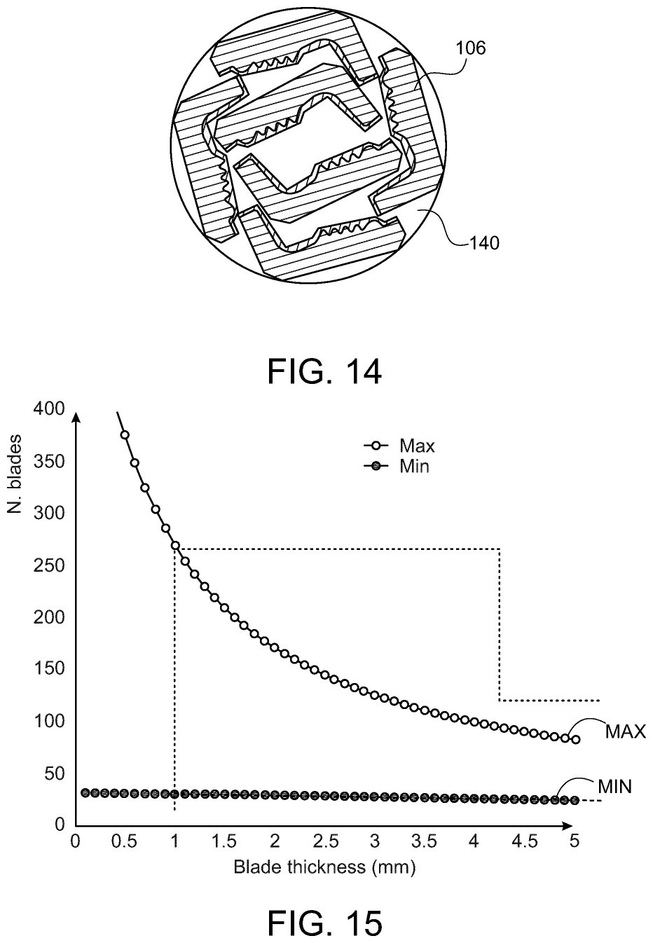

As shown in FIGS. 12 and 13, the abrasive segment further comprises a nesting surface 138 intermediate the outer surfaces of the first and second segment leg portions. The nesting surface is important for maximising the quantity of abrasive segments that can be extracted from a blank 140 during manufacturing—see FIG. 14. Typically, the blank is a disc of abrasive material, such as PCD backed with a carbide layer. By incorporating a nesting surface, when determining the appropriate nesting configuration, the quantity of abrasive segments that can be overlaid on to the blank is increased compared to overlaying abrasive segments that do not have a nesting surface. The nesting surface extends at an angle Y in the range of 30 to 50 degrees from the outer surface of the second segment leg portion, as indicated in FIG. 13. Preferably, angle Y is around 45 degrees.

In the hub of FIGS. 1 to 9, the quantity of slots and the corresponding quantity of abrasive segments is 80. This quantity had been determined by taking into account factors such as the target quantity of wheels to be machined by the tool, the rotational speed and the feed rate. There are also geometrical constraints to be consider such as the minimum spacing between abrasive segments (e.g. 15 mm) and/or the radial thickness of the supports (e.g. 0.75 mm).

The quantity of abrasive segments required is related to the total thickness, 1, of each abrasive segment and the diameter, D, of the hub. From experiments, the relationship between the quantity of abrasive segments, the thickness of the abrasive segments and the diameter of the hub has been captured empirically and can be defined by the two equations below:

$$Max = Int ( \frac{π D}{( l + 0.75 )} )$$

$$Min = Int ( \frac{π D}{( l + 15 )} )$$

In practice, where the hub is tapered (as in the first embodiment), the diameter used is actually the diameter measured to the minimum height of the profiled abrading edge. For hubs that do not taper, the diameter dimension is much simpler to identify.

For example, in the graph of FIG. 15, where 1=1 mm and D=150 mm, the quantity of abrasive segments required on the hub falls between the maximum, indicated at line Lₘₐₓ, and the minimum, indicated at line Lₘᵢₙ. It is possible to use quantity of abrasive segments outside of these two lines Lₘᵢₙ and Lₘₐₓ, but at some point it will comprise life and the number of wheels that can be machined by the tool.

For completeness, the total thickness of the abrasive segment in the first embodiment is around 3 mm and the diameter of the hub is around 140 mm. This gives a working range for the quantity of abrasive segments that may be used as 24 to 117, in which 80 was selected. Preferably, the thickness of the abrasive segment is in the range of 1 to 4 mm.

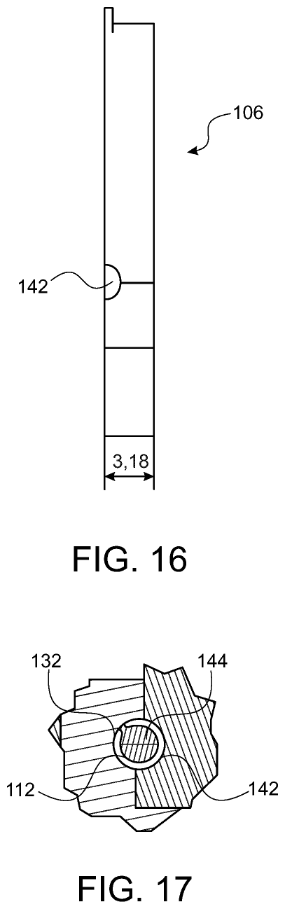

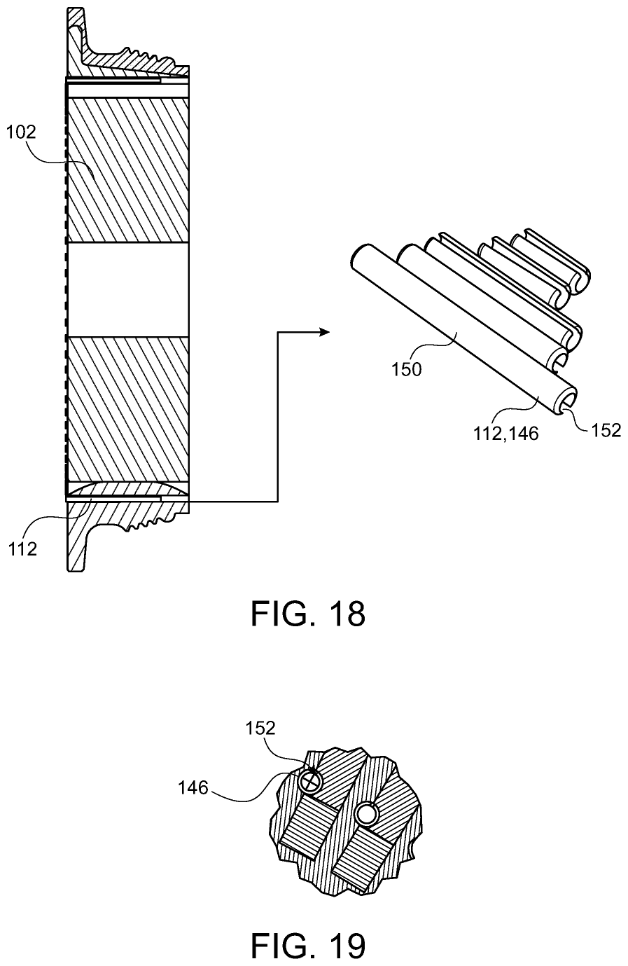

A second pin recess 142 having a semi-circular lateral cross-section extends along the longitudinal extent of the abrasive segment, best seen in FIG. 16. In the aforementioned final position, the second pin recess of the abrasive segment aligns with the first pin recess of the adjacent support, and together form a hole 144 with a circular lateral cross-section—see FIG. 17. When the pin element is inserted into this hole, it secures the abrasive element within the slot—see FIG. 18. The abrasive element can be removed from the hub simply by withdrawing the pin element.

The pin element may be a spring pin 146 (also known as a slotted spring tension pin), or it may be a threaded member such as a grub screw 148. In the first embodiment of the tool, the pin element is a spring pin, and is made from, e.g. galvanised spring steel. The spring pin is elongate and comprises a single coil 150 with an open gap 152 in an uncompressed state. When compressed, as occurs when the spring pin is driven into the hole created by the aligned first and second pin recesses, the spring pin reduces in diameter and due to its inherent spring bias urges to try and regain its uncompressed state. By this behaviour, the spring pin acts as a fastener between the abrasive segment and the hub. In the compressed state, the gap in the spring pin is aligned with surfaces of the abrasive segment and the support—see FIG. 19.

In the second and third embodiments of the tool described later, the pin element is a grub screw, or other similar type of threaded member.

Referring again briefly to FIG. 13, the abrading edge forms part of the second segment leg portion. In the final position, the abrading edge protrudes radially past the second support leg portion in order to function as intended. The abrading edge has a profile that is shaped into the second segment leg portion, for example, using laser machining. Since this profiling operation preferably takes place once the abrasive segments are located in-situ within their respective slots, as described in GB 2574492, a typical outline of the abrasive segment before and after profiling is shown at P and Q respectively. Outline P is essentially artificial and phantom, depicting the outline at a specific point in time. Ultimately, outline Q is (one of) the desired profile bestowed onto e.g. a wheel. In practice, the desired profile may be shaped into the abrading edge at any depth between lines P and Q, since the initial profile may be subsequently repeated at a lower depth during a reprofiling situation. Thus, the depth of abrasive material between lines P and Q may also be considered as a resharpening allowance.

A flange 154, also known as a backing plate, is mounted co-axially onto the hub, against the first major axial surface—see FIGS. 1 and 4. The flange is secured in place using a plurality of screws 156 and threaded holes 158 provided in the hub (FIG. 8), spaced apart from the abrasive segments. The flange helps prevents axial movement of the abrasive segments in extreme operating conditions. Optionally, the flange is an annular plate with a patterned surface (not shown). The patterned surface on or in the flange engages with a corresponding pattern on the hub in a mating arrangement. The cooperating patterns minimise relative rotation between the hub and the flange. Typically, the pattern is a series of recesses and/or protrusions. An example is shown in FIG. 11, in which the pattern includes a pair of inscribed arcuate recesses 160.

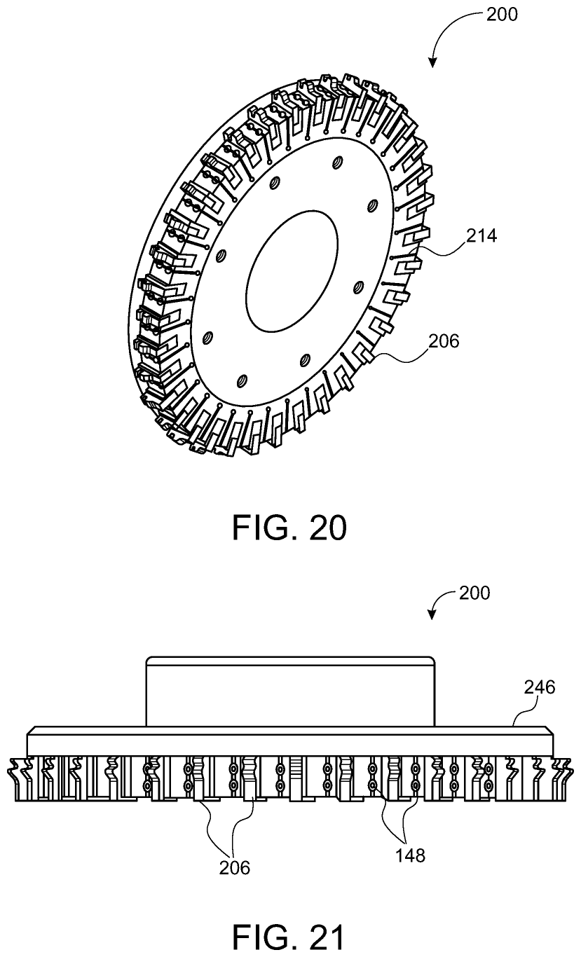

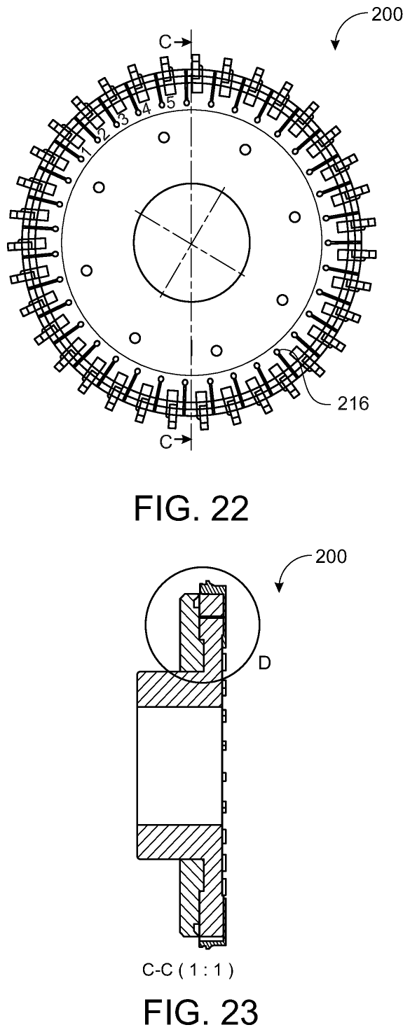

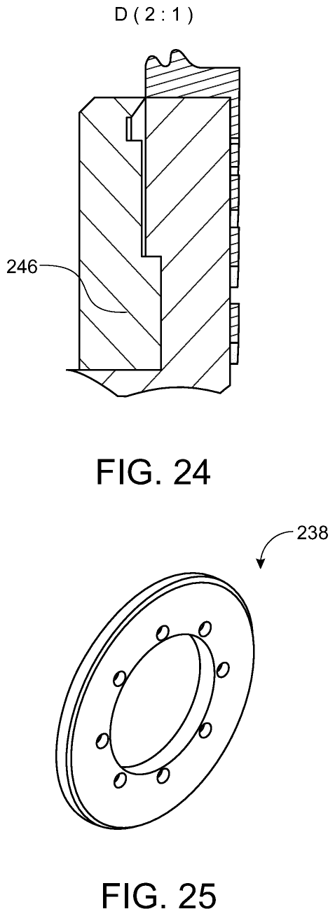

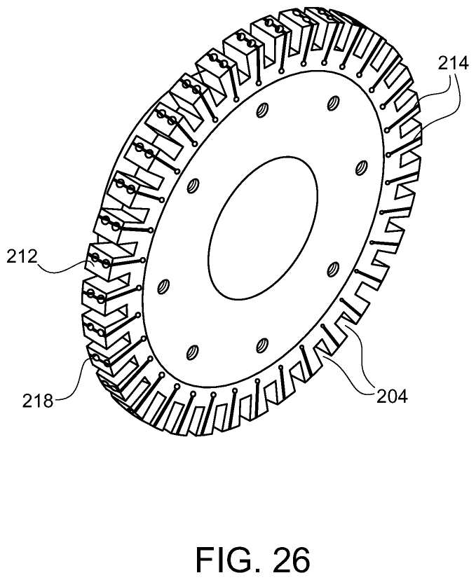

Turning now to FIGS. 20 to 26, a second embodiment of a rotary abrasive machining tool is indicated generally at 200. The rotary abrasive machining tool comprises a hub 202 with a plurality of axially extending radial slots 204 in an outer circumference thereof, and a plurality of abrasive segments 206 located in the radial slots. Each abrasive segment has a body 208 for mounting the abrasive segment in the hub and further comprises an abrading edge 210. Each abrasive segment is individually secured to the hub using a pin element 148 that extends at least partially through the abrasive segment and/or at least partially through the hub adjacent the abrasive segment. In this second embodiment, the pin element extends partially through the hub, adjacent the abrasive segment.

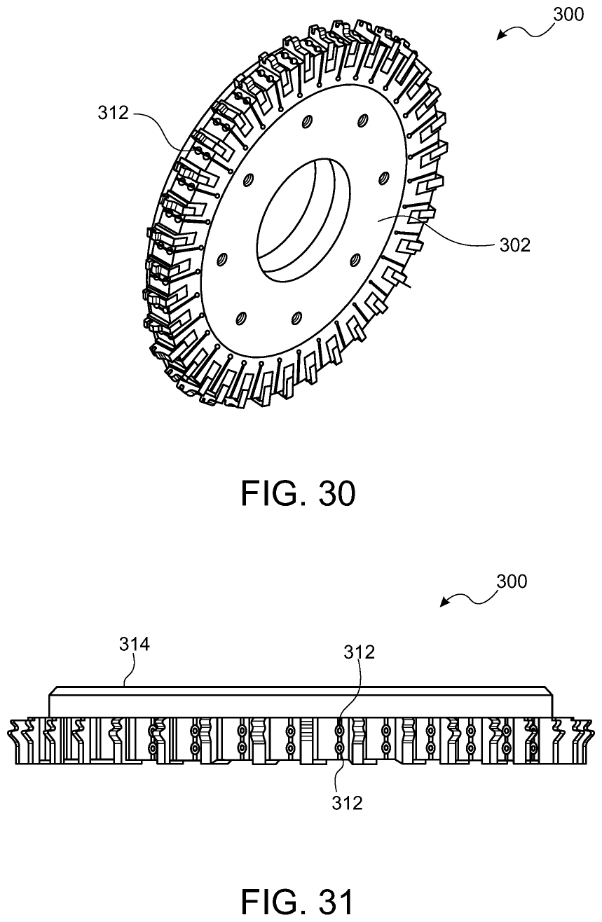

Specifically, the pin element is inserted radially into the circumferential surface 212 of the hub, in between adjacent abrasive segments. In cooperation with a series of radially extending slits 214, the pin elements are used to help clamp the abrasive segments in position within the slots. The slits extend into the hub, alongside the slots and on both sides. At the base of each slit is an axially extending aperture 216 with a circular cross-section for reducing the risk of crack initiation. The hub also comprises a plurality of radially extending holes 218 that adjoin the slits. Optionally, one (FIGS. 20 and 30) or two (FIG. 37) holes are provided in each slit. Once all the abrasive segments have been inserted into their respective slots, a pin element is inserted into each of the radially extending holes, thereby causing the slits to close up, clamping the abrasive segments in position. It is important that the slits are closed up one by one, and sequentially (always the adjacent one) around the hub for balanced load transfer and therefore maximum effect.

In this embodiment, the abrasive segments are each individually mounted in a slot via an intermediate abrasive segment holder 220. In this way, the pressure required to retain the abrasive segment in position is achieved without having to fill the entire slot with highly wear resistant material. The intermediate holder essentially acts as a substitute for the more expensive PCD material. This is possible because the lower portion of the abrasive segment is only required to mount the abrasive segment in the holder, it does not actually need to be particularly wear resistant as it never comes into contact with the grinding wheel.

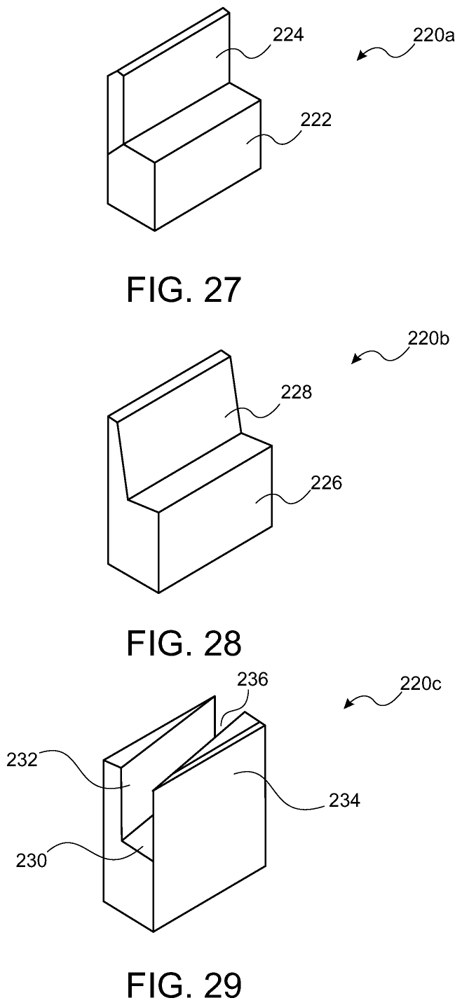

Examples of suitable abrasive segment holders are shown in FIGS. 27, 28 and 29. The abrasive segment holders are typically made of steel. In FIG. 27, the abrasive segment holder 220a comprises a seat 222 and a back 224 that is perpendicular to the seat. In FIG. 28, the abrasive segment holder 220b comprises a seat 226 and a back 228 that is inclined with respect to the seat. In use, the abrasive segment holders of FIGS. 27 and 28 are oriented with their backs behind the abrasive segment defined with respect to the forward rotational direction of the hub. In FIG. 29, the abrasive segment holder 220c comprises a seat 230 and two spaced apart backs 232, 234 that are perpendicular to the seat. The backs have a triangular longitudinal cross-section. A slot 236 is defined by the two backs, into which the abrasive segment is received.

During testing it was found that the first and second embodiments of the abrasive segment tool holders proved more problematic than expected. When supporting the abrasive segment, there was often misalignment on the leading face between the abrasive segment and the abrasive segment holder. Due to tolerancing issues, the abrasive segment either projected past the leading face of the abrasive segment holder, or the abrasive segment holder projected past the abrasive segment. Either way, the load on the leading face was not distributed across both the abrasive segment and the holder. This subsequently lead to the development of the third embodiment, which transfers load evenly from holder to abrasive segment since the abrasive segment is located within the slot between the two backs. A variant of this third embodiment is shown in FIG. 37.

In this second embodiment of the tool, the hub is not tapered radially inwardly from a first major axial surface to a second major axial surface. Instead, the circumferential surface is generally perpendicular to the first and second major axial surfaces—see FIG. 23. This keeps the tool suitable for many types of rotary abrasive machining application, but renders it less suitable for grinding complex profiles such as fir-tree profiles.

Also in this embodiment, there are significantly fewer abrasive segments and slots. This rotary abrasive machining tool is better suited for machining operations requiring a smaller diameter. It also makes it ideal as a test jig used for optimising operational parameters due to its lower cost compared to the first embodiment.

Finally, a flange 238 is mounted on the hub in a similar manner to before.

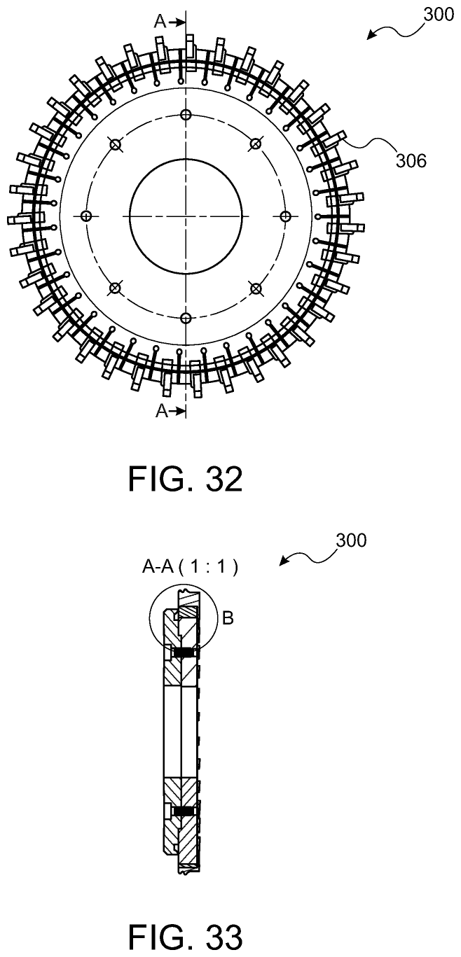

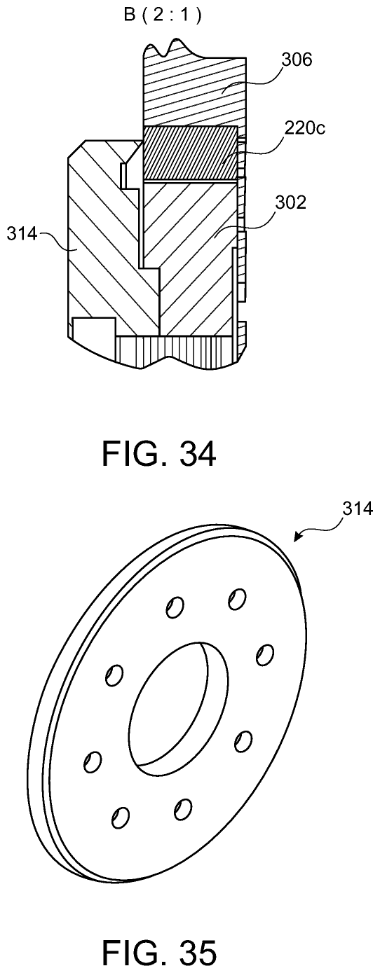

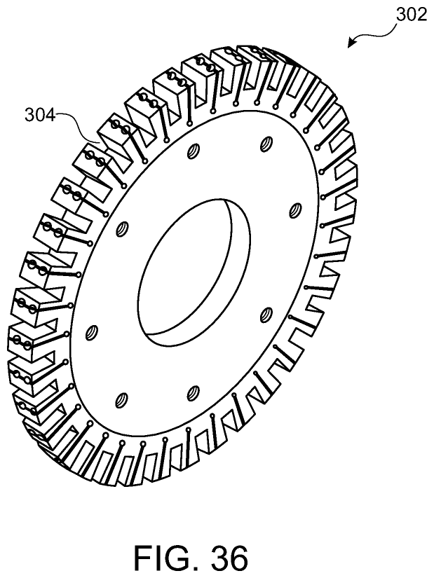

Turning now to FIGS. 30 to 36, a third embodiment of a rotary abrasive machining tool is indicated generally at 300. The rotary abrasive machining tool comprises a hub 302 with a plurality of axially extending radial slots 304 in an outer circumference thereof, and a plurality of abrasive segments 306 located in the radial slots via intermediate holders. Each abrasive segment has a body 308 for mounting the abrasive segment in the hub and further comprises an abrading edge 310. Each abrasive segment is individually secured to the hub using a pin element 312 that extends at least partially through the abrasive segment and/or at least partially through the hub adjacent the abrasive segment. As with the second embodiment, in the third embodiment, the pin element extends partially through the hub adjacent the abrasive segment.

The second and third embodiments are very similar, and so only the key difference is highlighted here. In the third embodiment, the hub does not have a raised surface; both the hub and flange 314 are annular and they lie flat against each other co-axially. By contrast, in the second embodiment, the flange is mounted about the raised surface of the hub.

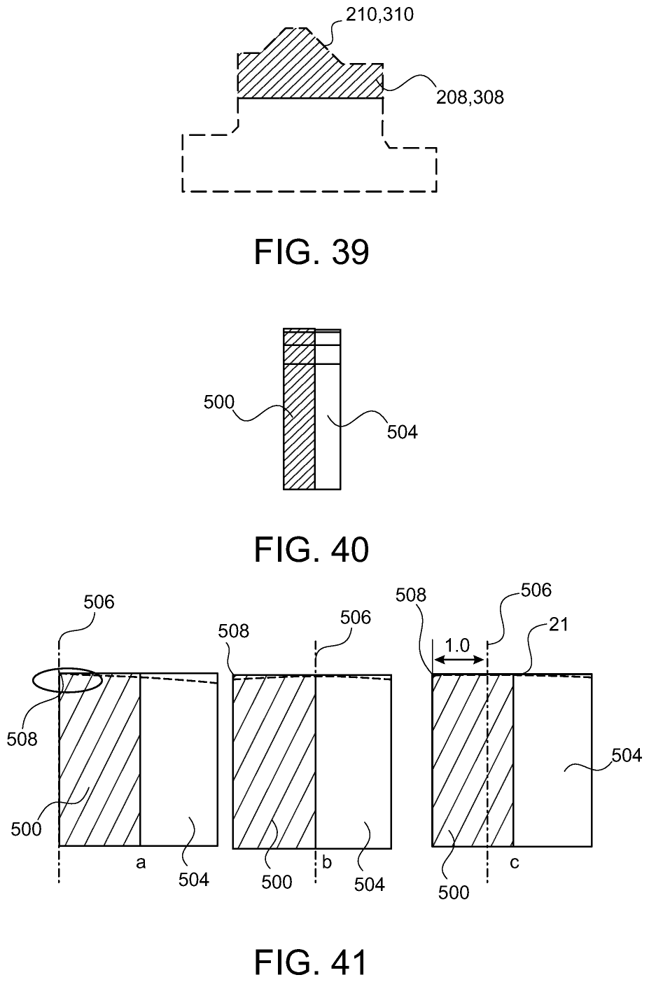

Turning now to FIGS. 37 and 38, a fourth embodiment of a rotary abrasive machining tool is indicated generally at 400. The rotary abrasive machining tool comprises a hub 402 with a plurality of axially extending radial slots 404 in an outer circumference thereof, and a plurality of abrasive segments 406 located in the radial slots. Each abrasive segment has a body 408 for mounting the abrasive segment in the hub and further comprises an abrading edge 410. Each abrasive segment is individually secured to the hub using a pin element (not shown) that extends at least partially through the abrasive segment and/or at least partially through the hub adjacent the abrasive segment. As with the second embodiment, in the fourth embodiment, the pin element extends partially through the hub adjacent the abrasive segment.

The second and fourth embodiments are very similar, and so only the key difference is highlighted here. In the fourth embodiment, the type of abrasive segment holder 220 is different, as mentioned previously. The abrasive segment holder 220d comprises a seat 412 and two spaced apart backs 414, 416 that are perpendicular to the seat. The backs have a rectangular longitudinal cross-section. The abrasive segment is clamped in place in the holder 220d. The holder is in turn clamped in place in the hub.

Furthermore, only one pin element is used as part of the clamping mechanism, again as mentioned previously. Two smaller pin elements enable a better load transfer onto the abrasive segments but a single larger pin element works as effectively.

For each of the various tool embodiments described above, each abrasive segment preferably comprises PCD. Preferably, the PCD is provided as a layer 500 having a thickness in the range of 1 to 2 mm. Although using PCBN is feasible, PCD is superior in terms of wear resistance due to its extreme hardness. The downside is that PCD is more expensive than PCBN, so there is a trade-off between performance and cost. FIG. 39 is used to show the volume of PCD used in the abrasive segments of the second, third and fourth tool embodiments is much reduced compared with the abrasive segment of the prior art. The same finding broadly applies to the L-shaped abrasive segment in the first embodiment.

Optionally, the abrasive segment also comprises a carbide substrate 502 which adjoins the PCD at an interface 504—see FIG. 40. The location of this interface relative to the centreline 506 of the hub is paramount. It is important that the interface is positioned off-centre with respect to the centreline of the hub, as in the example provided in FIG. 41a. In other words, the interface should not align with the centreline, as in the example provided in FIG. 41b. Ideally, the centreline coincides with the PCD layer of the abrasive segment, as in the example provided in FIG. 41c.

In FIG. 41a, the geometry on the cutting edge 508 would be lost prematurely due to wear, which is bad, but the PCD would wear, which is good. Tests have shown that should the interface align with the centreline, as with FIG. 41b, premature failure of the abrasive segment is likely to occur, with cracks initiating at the interface. In FIG. 41c, the geometry on the cutting edge is preserved and wear begins on the PCD layer, both of which are good.

In practice, the location of the interface relative to the centreline of the hub is achieved by altering the proportion of PCD layer to carbide layer. Preferably, a total thickness of the abrasive segment (i.e. PCD and, if present, also the carbide layer) is less than 5 mm, and it is more preferably less than 4 mm. Preferably, the ratio of PCD layer to carbide if present is in the ratio of 1 to 3.

The rotary abrasive machining tool may be configured as a grinding wheel, a rotary dressing tool or any other similar form of machining tool. As mentioned previously, the rotary abrasive machining tool is particularly useful for the dressing of grinding wheels having profiles of complex geometry, such as fir-tree profiles.

In summary, the inventors have devised an alternative method of mounting abrasive segments in a hub for rotary abrasive machining applications. This new method is more cost effective from a construction perspective due to the reduced volume of wear resistant material required in the abrasive segments, and it is also more flexible from a servicing perspective, due to the capability of replacing and reprofiling individual segments.

While this invention has been particularly shown and described with reference to embodiments, it will be understood by those skilled in the art that various changes in form and detail may be made without departing from the scope of the invention as defined by the appended claims.

1. A rotary abrasive machining tool comprising a hub with a plurality of axially extending radial slots in an outer circumference thereof, a plurality of abrasive segments located in the radial slots, each abrasive segment having a body for mounting the abrasive segment in the hub and further comprising an abrading edge, characterised in that each abrasive segment is individually secured to the hub using a pin element that extends at least partially through the abrasive segment and/or at least partially through the hub adjacent the abrasive segment.

2. A rotary abrasive machining tool as claimed in claim 1, the abrasive segment comprising a first partial aperture and the hub comprising a second partial aperture, the first and second partial apertures together forming a complete aperture when the abrasive segment is in the slot and when the first and second partial apertures align.

3. A rotary abrasive machining tool as claimed in claim 1, wherein the abrasive segment is L-shaped and comprises a first leg portion extending from a second leg portion.

4. A rotary abrasive machining tool as claimed in claim 3, wherein the second leg portion extends at an angle X to the first leg portion, angle X being measured between outer surfaces of the first and second leg portions, angle X being in the range of 75 to 100 degrees.

5. A rotary abrasive machining tool as claimed in claim 3, the abrasive segment further comprising a nesting surface intermediate outer surfaces of the first and second leg portions.

6. A rotary abrasive machining tool as claimed in claim 5, wherein the nesting surface extends at an angle in the range of 30 to 50 degrees to the outer surface of the second leg portion.

7. A rotary abrasive machining tool as claimed in claim 1, wherein the hub tapers from a first side to a second side.

8. A rotary abrasive machining tool as claimed in claim 1, wherein the hub comprises an L-shaped support.

9. A rotary abrasive machining tool as claimed in claim 1, wherein the hub comprises a patterned axial surface for coupling with a correspondingly patterned axial surface on a flange in a mating arrangement.

10. A rotary abrasive machining tool as claimed in claim 1, further comprising a flange.

11. A rotary abrasive machining tool as claimed in claim 10, wherein the flange comprises a patterned axial surface for coupling with a correspondingly patterned axial surface on the hub in a mating arrangement.

12. A rotary abrasive machining tool as claimed in claim 1, the hub comprising a plurality of radially extending slits that terminates at a peripheral surface of the hub.

13. A rotary abrasive machining tool as claimed in claim 12, wherein the slit extends alongside the radial slot.

14. A rotary abrasive machining tool as claimed in claim 13, the slit further comprising one or more radially extending closed holes for receiving grub screws.

15. A rotary abrasive machining tool as claimed in claim 12, further comprising an abrasive segment holder intermediate the hub and the abrasive segment.

16. A rotary abrasive machining tool as claimed in claim 1, wherein the abrasive segment comprises polycrystalline diamond (PCD).

17. A rotary abrasive machining tool as claimed in claim 16, further comprising a carbide substrate adjoining the PCD at an interface.

18. A rotary abrasive machining tool as claimed in claim 17, wherein the interface is located off-centre with respect to a centreline of the hub.

19. A rotary abrasive machining tool as claimed in claim 16, wherein the PCD is provided as a layer having a thickness in the range of 1 to 2 mm.

20. A rotary abrasive machining tool as claimed in claim 16, wherein a total thickness of the abrasive segment is less than 5 mm, preferably less than 4 mm.
